(19) United States
(12) Patent Application Publication
(10) Pub. No.: US 2011/0154033 A1
(43) Pub. Date: Jun. 23, 2011

(54) ONLINE STORAGE SERVICE SYSTEM AND ITS DATA CONTROL METHOD

(75) Inventors: Hiroshi Nakagoe, Tokyo (JP); Takaki Nakamura, Ebina (JP); Yohsuke Ishii, Yokohama (JP); Nobuaki Kohinata, Yokohama (JP)

(73) Assignee: Hitachi, Ltd.

(21) Appl. No.: 12/526,775

(22) PCT Filed: Apr. 23, 2009
(86) PCT No.: PCT/JP2009/058542

§ 371 Date: Aug. 11, 2009

(51) Int. Cl. H04L 9/32; G06F 15/16

(52) U.S. Cl. 713/168

(57) ABSTRACT

A WEB service providing server can execute WEB service processing using data provided by an online storage service providing server, and leaking of data at the WEB service providing server can be prevented.

A WEB service providing server 102 requests, in response to a service request from a client terminal 100, that an online storage service providing server 101 provides data that will satisfy the service request. The online storage service providing server 101 extracts content data from storage devices, encrypts the extracted content data, and provides the WEB service providing server 102 with storage service data composed of data including the encrypted content data and metadata. The WEB service providing server 102 constructs a WEB service screen according to the metadata and provides the client terminal 100 with the constructed WEB service screen.

### TECHNICAL FIELD

The present invention relates to an online storage service system for providing a client terminal with a storage service via a network such as the Internet. More particularly, the invention relates to a technique for safely managing user data stored in an online storage service providing server that lends storage devices to a user, the client terminal, via the network.

### BACKGROUND ART

Along with speed-up of accesses to networks and popularization of flat-rate communication cost services, pages composed of CGM (Consumer Generated Media) that are data generated by consumers are being added to pages composed of data provided by enterprises, professional writers, and editors on the Internet WEB pages.

Specifically speaking, WEB pages provided with CGM are pages on the Internet for collecting users' word-of-mouth information and introducing users' direct opinions and impressions, which have been difficult to introduce by means of evaluation by mass media. On this type of WEB pages, there are word-of-mouth communication sites where the aforementioned word-of-mouth information can be shared with other users, and social networking sites (SNS) providing the places where users can communicate with each other on the Internet.

On recent WEB pages, page structures and layout are described in HTML (Hyper Text Markup Language). Under such circumstances, the conventional form of service in which a WEB page providing server provides a client terminal with pages in which data held by the WEB page providing server is embedded has been changing to the form of service in which the WEB page providing server provides the client terminal with XML markup data marked up in XML (eXtensible Markup Language) and software for controlling the XML markup data. Incidentally, a WEB page provision method using the above-mentioned XML data will be hereinafter referred to as the “WEB service.”

Furthermore, the above-mentioned WEB service has been developed to the form of service in which software components provided by a plurality of WEB service providing servers are combined to provide another service. WEB service providing servers provide service APIs (Application Programming Interfaces) in a standardized software language so that they can cooperate with other WEB services.

As a specific example of the form of service in which service APIs provided by a plurality of WEB service providing servers are combined to provide another WEB service, there is a service by which when a user designates the location or type of restaurants, information about restaurants that meet the designated conditions, for example, the names of restaurants and word-of-mouth communication information, is displayed in the area designated by the user on the map, using Google Local API which is a map information search service provided by Google (see Non-patent Document 1), and Gurunavi (Gourmet Navigator) API which is a restaurant search service provided by K. K. Grunavi (see Non-patent Document 2).

Regarding the WEB service API, data is often delivered in XML and software for controlling XML data is often provided in JavaScript (registered trademark) or HTML.

On the other hand, as a result of the widespread use of computers and realization of highly-sophisticated features of computers, the capacity of content data such as documents, photographs, sounds, music, and moving images created and held by users has been increasing and there is a growing demand for storages devices for storing data. In response to the demand for storage devices, many storage vendors adopt a home NAS (Network Attached Storage) system by which large-capacity storage devices can be provided on the home networks at users' home, or adopt an online storage service system that lends server storage devices on the Internet as described in Patent Document 1 and enables writing/reading of user data to/from the storage devices.

From among these systems, attention has been focused on the online storage service system not only because of its low initial cost and easy initial installation, but also because of easy worldwide accessibility via the Internet.

The conventional WEB service has been realized in the manner such that a WEB service providing server marks up data logically stored in that server, describes software for controlling the XML markup data in a language such as JavaScript, and provides a client terminal with HTML pages including the XML markup data and the control software. However, as the online storage service system become widespread among users, it can be assumed that the WEB service will be offered by using data provided by the online storage service system.

Thus, the WEB service using the conventional CGM has been offered in a manner such that a user marks up data uploaded to the WEB service providing server, using XML, describes software for controlling the XML markup data in a language such as JavaScript, and provides the client terminal with HTML pages including the XML markup data and the control software.

However, from now on, the WEB service providing server will obtain data, which has been already uploaded by a user to the online storage service providing server, via a WEB service API provided by the online storage service providing server, mark up the obtained data using XML, describe software for controlling the XML markup data in a language such as JavaScript, and provide the client terminal with HTML pages including the XML markup data and the control software.

This change will be made because when a user intends to use data stored in the online storage service providing server using the WEB service, the user has to download the data once from the online storage service providing server to the client terminal operated by the user and then upload the downloaded data to the WEB service providing server, thereby increasing burden on the user as compared to the conventional method of simply uploading data stored in the client terminal to the WEB service providing server.

### RELATED ART DOCUMENTS

[Patent Document 1] Published Japanese Translation No. 2003-514279 of the PCT International Publication

[Non-patent Document 1] http://code.Google.com/apis/maps/index.html

[Non-patent Document 2] http://api.Gnavi.co.jp/api/manual.htm

### DISCLOSURE OF THE INVENTION

Specifically speaking, when the online storage service providing server realizes a WEB service API that enables access to data stored in that server, using the technique described in Patent Document 1, there is a case where the client terminal operated by a user does not directly access the online storage service providing server realized by the technique described in Patent Document 1, using HTTP (Hypertext Transfer Protocol), but the client terminal uses data stored in the online storage service providing server via a WEB service providing server different from the online storage service providing server.

In this case, the user uploads data stored in the client terminal to the online storage service providing server in advance. When the user accesses the WEB service providing server from the client terminal in order to use the WEB service provided by the WEB service providing server, the WEB service providing server requests necessary data from the online storage service providing server when providing the user with the WEB service.

The online storage service providing server sends the data requested by the WEB service providing server to the WEB service providing server. The WEB service providing server transfers the WEB service, which uses the data sent from the online storage service providing server, to the client terminal. In this situation, the online storage service providing server transfers the data stored in storage devices in its own server to the WEB service providing server without converting it.

If the WEB service providing server is provided by an administrator with malicious intentions in the above-described circumstances, the WEB service providing server stores the raw data without conversion in cache memory, so that it can make unauthorized secondary use of the data. Therefore, there is a risk of infringement upon the user's privacy due to leaking of the user data.

In this case, the risk of secondary use of data can be prevented by having the WEB service providing server encrypt and transfer the relevant data in response to a data request from the WEB service providing server. However, the WEB service providing server is often managed by an administrator different from that of the online storage service providing server. Under the circumstances where the WEB service providing server does not have the function analyzing the data encrypted by the online storage service providing server, it is impossible to analyze the encrypted data and, therefore, it is difficult to provide the service.

When the user accesses the WEB service provided by the WEB service providing server from the client terminal, the risk of secondary use of user data stored in the online storage service providing server can be prevented by transferring the data from the client terminal to the online storage service providing server without passing through the WEB service providing server. However, as in the case of the aforementioned encrypting method, the WEB service providing server cannot analyze the data and, therefore, it is difficult to provide the WEB service.

In other words, there is a trade-off relationship between leaking of user data and the possibility of provision of the service by an external WEB service providing server which is different from the online storage service providing server; and it has been impossible to realize both the prevention of leaking of user data and the provision of the service by the external WEB service providing server which is different from the online storage service providing server.

The present invention was devised in light of the above-described circumstances. It is an object of the invention to provide an online storage service system and its data control method by which a WEB service providing server can execute WEB service processing, using data provided by an online storage service providing server, and leaking of data can be prevented when the data is used by the WEB service providing server.

In order to achieve the above-described object, the present invention is characterized in that when a WEB service providing server which has received a service request from a client terminal provides the client terminal with the WEB service via a network, the WEB service providing server requests, via the network, provision of data that will satisfy the service request, from the online storage service providing server; and the online storage service providing server extracts content data from storage devices, encrypts at least part of the content data, and provides the WEB service providing server with storage service data including the encrypted content data; and the WEB service providing server generates WEB structure data that complies with the service request, based on data which is not encrypted in the supplied storage service data, and then provides the client terminal with a WEB service message composed of data including the generated WEB structure data and the storage service data.

### EFFECT OF THE INVENTION

According to the present invention, a WEB service providing server can execute WEB service processing using data provided by an online storage service providing server; and when the WEB service providing server uses the data, leaking of data can be prevented and, therefore, infringement upon users' privacy can be prevented.

### BRIEF DESCRIPTION OF THE DRAWINGS

FIG. 1 is a block diagram of an online storage service system according to the first embodiment of the present invention;

FIG. 2 is a flowchart for explaining preliminary processing executed between a client terminal and an online storage service providing server according to the first embodiment of the present invention;

FIG. 3 is a flowchart for explaining processing executed in the entire online storage service system according to the first embodiment of the present invention;

FIG. 4 is a flowchart for explaining data transfer processing executed by the online storage service providing server according to the first embodiment of the present invention;

FIG. 5 is a flowchart for explaining data reception processing executed by the client terminal according to the first embodiment of the present invention;

FIG. 6 is a block diagram of an online storage service system according to the second embodiment of the present invention;

FIG. 7 is a flowchart for explaining preliminary processing executed between a client terminal and an online storage service providing server according to the second embodiment of the present invention;

FIG. 8 is a flowchart for explaining processing executed in the entire online storage service system according to the second embodiment of the present invention;

FIG. 9 is a flowchart for explaining data transfer processing executed by the online storage service providing server according to the second embodiment of the present invention;

FIG. 10 is a flowchart for explaining data reception processing executed by the client terminal according to the second embodiment of the present invention; and

FIG. 11 is a flowchart for explaining data edition processing executed by the client terminal according to the second embodiment of the present invention.

### BEST MODE FOR CARRYING OUT THE INVENTION

### First Embodiment

The first embodiment of the present invention will be explained below in detail with reference to the attached drawings. Incidentally, the same reference numeral used in all the drawings has the same function and, therefore, an explanation of that reference numeral will not be repeated.

The first embodiment is designed so that an online storage service providing server encrypts content data and provides a WEB service providing server with storage service data composed of data including the encrypted content data and metadata which is additional information for the content data; and the WEB service providing server creates a WEB service message according to the metadata in the data provided by the online storage service providing server and provides the client terminal with data relating to the created WEB service message.

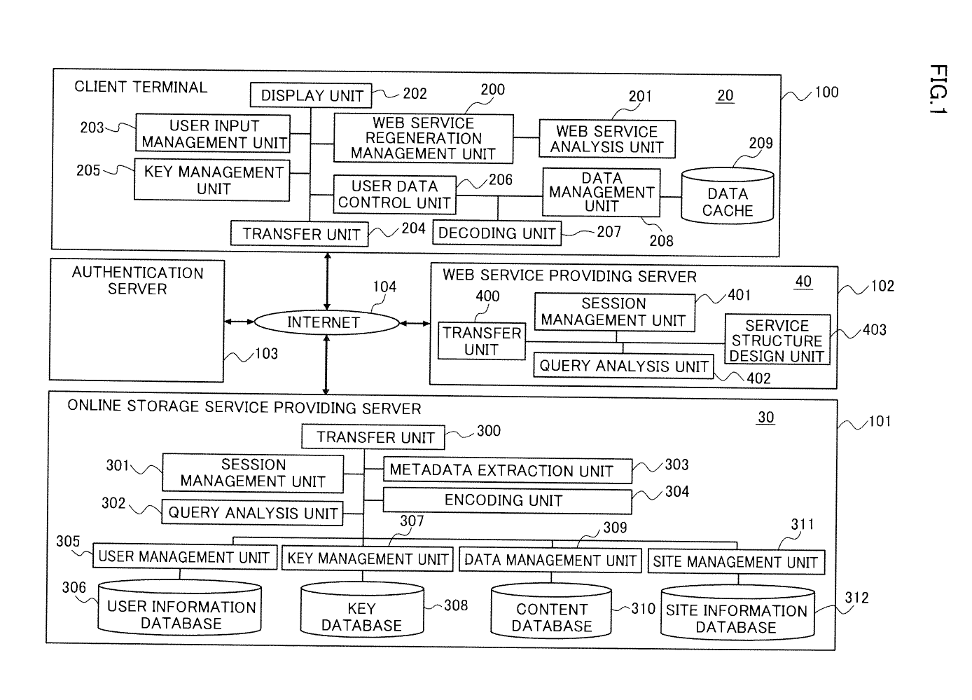

FIG. 1 is a block diagram of an online storage service system according to the first embodiment of the present invention.

Referring to FIG. 1, the online storage service system is constituted from a client terminal 100, an online storage service providing server 101, a WEB service providing server 102, and an authentication server 103. The client terminal 100, the online storage service providing server 101, the WEB service providing server 102, and the authentication server 103 are coupled with each other via a network 104. Incidentally, the network 104 according to the first embodiment is, for example, the Internet.

The client terminal 100 includes a terminal control device 20. The terminal control device 20 is constituted from a WEB service regeneration management unit 200, a WEB service analysis unit 201, a display unit 202, a user input management unit 203, a transfer unit 204, a key management unit 205, a user data control unit 206, a decrypting unit 207, a data management unit 208, and data cache (cache memory) 209.

The WEB service regeneration management unit 200 is a platform for receiving a WEB service message that is a constituent element of the WEB service provided by the WEB service providing server 102, and regenerating the service on the client terminal 100. The WEB service regeneration management unit 200 is, for example, browser software.

The WEB service analysis unit 201 analyzes the logical structure of the WEB service message and the layout of the message. The WEB service analysis unit 201 indicates, for example, an HTML analytical engine or JavaScript analytical engine controlled by the browser.

The display unit 202 displays a WEB service screen constructed by the WEB service regeneration management unit 200 and notifies the user that the WEB service screen is displayed. The user input management unit 203 performs input control of the WEB service regeneration management unit 200 when the user takes action. The transfer unit 20 sends and receives data generated when the client terminal 100 communicates with the online storage service providing server 101 and/or the WEB service providing server 102.

The key management unit 205 stores key data to be used when the encrypted data provided by the online storage service providing server 101 is decrypted; and the key management unit 205 manages the key data it stores.

The user data control unit 206 is a block prepared when managing and controlling data provided by the online storage service providing server 101 and serves as an interface when the WEB service regeneration management unit 200 handles data provided by the online storage service providing server 101.

The decrypting unit 207 decrypts the encrypted data provided by the online storage service providing server 101. The data management unit 208 controls access to the data cache 209 that stores data provided by the online storage service providing server 101. The data cache 209 is a database for temporarily storing data provided by the online storage service providing server 101.

Incidentally, a period of time when the data cache 209 manages the data provided by the online storage service providing server 101 may be either a period of time when the WEB service regeneration management unit 200 manages the WEB service provided by the online storage service providing server 101 or the WEB service providing server 102, or a period of time designated by the user for the WEB service regeneration management unit 200. This period of time is not particularly defined according to the first embodiment.

The user data control unit 206, the decrypting unit 207, the data management unit 208, and the data cache 209 may be either software programs contained in the WEB service message provided by the online storage service providing server 101 to the WEB service providing server 102 and transferred by the WEB service providing server 102 or add-on programs belonging to the WEB service regeneration management unit 200.

The online storage service providing server 101 includes a storage control device 30. The storage control device 30 is constituted from a transfer unit 300, a session management unit 301, a query analysis unit 302, a metadata extraction unit 303, an encrypting unit 304, a user management unit 305, a user information database 306, a key management unit 307, a key database 308, a data management unit 309, a content database 310, a site management unit 311, and a site information database 312. The user information database 306, the key database 308, the content database 310, and the site information database 312 constitute elements of storage devices.

The transfer unit 300 is similar to the transfer unit 204. The session management unit 301 manages a series of communications (sessions) for receiving a service request from the client terminal 100 or the WEB service providing server 102 and responding to the service request. The query analysis unit 302 analyzes syntax of a query, which is an inquiry transferred from the client terminal 100 or the WEB service providing server 102, and comprehends the content of the inquiry.

Incidentally, how to express queries does not matter in this embodiment. The metadata extraction unit 303 extracts information relating to content data (for example, metadata that is additional information for content data) from data stored in the content database 310 (for example, content data relating to users).

The metadata extracted by the metadata extraction unit 303 are: data file names, update dates and times, data size, and types of data contained in directory entries managed by a common file system; metadata embedded in the content data; and tag data that can be transmitted as character information as a result of analysis of the content data.

The metadata embedded in the content data include: regarding photographic data, shooting dates and times, photographing equipment manufacturers' names, models' names, resolution of photo images, shooting directions, shooting places, and setting data (such as a shutter speed and an ISO sensitivity value) at the time of photographing that are stored in the Exif format compatible with JPEG and TIFF formats; and regarding music data, titles, artists' names, album titles, dates, genres, and track numbers stored in the ID3 format compatible with the MP3 format.

The tag data that can be transmitted as character information as a result of analysis of the content data include: regarding photographic data, a “smile” tag indicating that the relevant photographic data is a photograph including a smile, and a “specific person's name” tag indicating that the relevant photographic data is a photograph including a specific person; and regarding music data, tags such as “healing” and “up-tempo.” Incidentally, how to analyze the content data does not specifically matter.

The encrypting unit 304 encrypts the content data stored in the content database 310, using key data stored in the key database 308. Incidentally, an encrypting algorithm used by the encrypting unit 304 may be an existing common key encrypting algorithm and is not particularly defined in this embodiment.

The user management unit 305 controls access to user information stored in the user information database 306.

The user information database 306 stores information about users who use the WEB service provided by the online storage service providing server 101.

The user information database 306 stores, for example, information about the relevant contract with the user, information about relationship between the user and the content data stored in the content database 310, information including the user's right to access the content data stored in the content database 310, the stored data capacity of the content data stored by the user in the content database 310, information including the stored data quantity, the usage history of the WEB service provided by the online storage service providing server 101, and the usage history of user data stored in the content database 310 when using the WEB service provided by the WEB service providing server 102.

The key management unit 307 controls access to key data stored in the key database 308. The key database 308 stores the key data used when the encrypting unit 304 encrypts the content data (user data) stored in the content database 310. The key data is stored in the key database 308 in the state where it is linked with user information stored in the user information database 306.

The data management unit 309 controls access to data stored in the content database 310. The content database 310 is a database for storing data uploaded by the client terminal 100.

The site management unit 311 controls access to WEB site information data stored in the site information database 312. The site information database 312 stores information about sites for which encrypting by the encrypting unit 304 is unnecessary, when transferring the content data stored in the content database 310 to sites outside the online storage service providing server 101.

The WEB service providing server 102 includes a WEB service control device 40. The WEB service control device 40 is constituted from a transfer unit 400, a session management unit 401, a query analysis unit 402, and a service structure design unit 403. The transfer unit 400 is similar to the transfer unit 204.

The session management unit 401 manages sessions, a series of communications, for receiving a service request from the client terminal 100 and responding to the service request. The query analysis unit 402 analyzes a query which is a user request transferred from the client terminal 100.

As in the case of the query analysis unit 302, how to express equerries does not matter in this embodiment.

The service structure design unit 403 designs and constructs a WEB service message regarding the WEB service provided by the WEB service providing server 102, that can be analyzed by the WEB service analysis unit 201 for the client terminal 100.

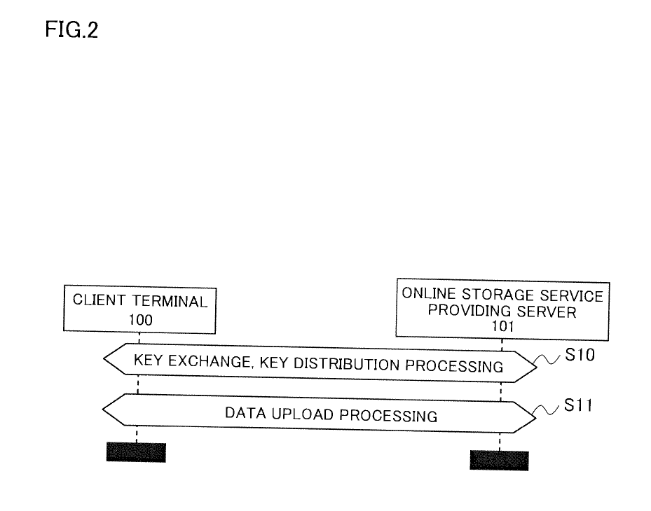

Next, the operation of the online storage service system according to the first embodiment will be explained with reference to FIGS. 2 to 5.

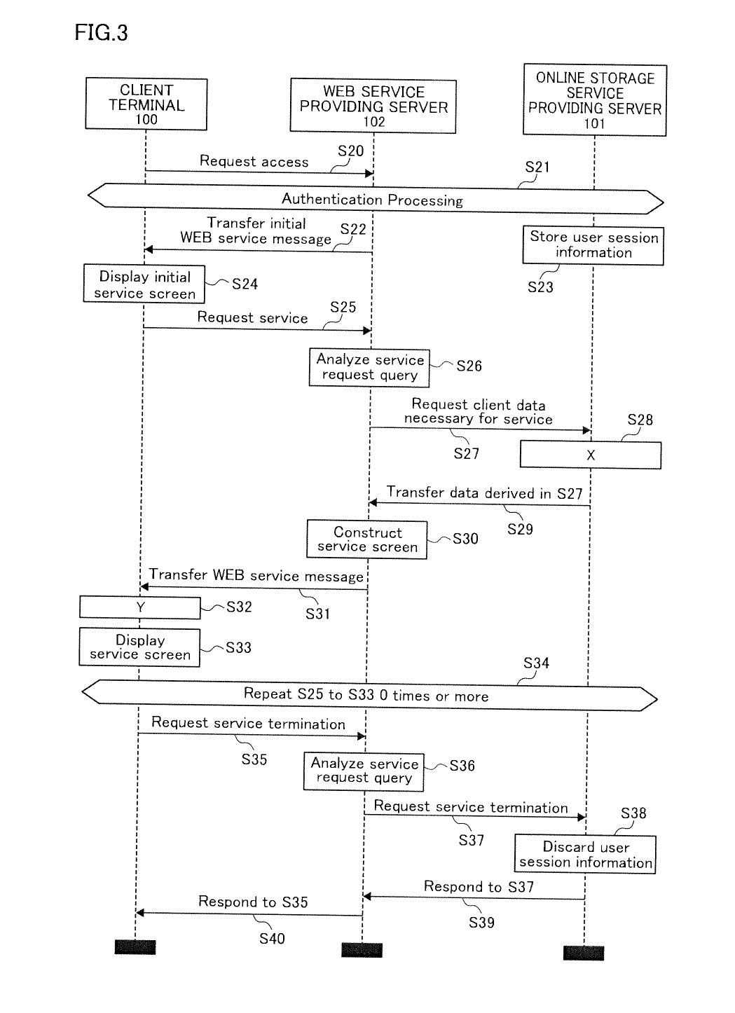

FIG. 2 shows a flow of processing executed between the client terminal 100 and the online storage service providing server 101. The processing flow shown in FIG. 2 has to be executed before processing flows shown in FIGS. 3 to 5.

Referring to FIG. 2, the client terminal 100 exchanges the key data linked with the user who operates the client terminal 100, with the online storage service providing server 101. Alternatively, when the key data linked with the user who operates the client terminal is distributed from the online storage service providing server 101 to the client terminal 100, the client terminal 100 stores the key data in the key management unit 205 (S10).

Incidentally, how to exchange or distribute the key does not matter in this embodiment. The key exchange or distribution may be performed using a known key exchange algorithm or the user may manually set the key to the key management unit 205 as designated when the user enters into a contract with a vender providing the online storage service providing server 101.

Subsequently, CGM such as data created by the client terminal 100 is uploaded from the client terminal 100 to the online storage service providing server 101 (S11). Incidentally, how to upload the data described above does not matter in this embodiment.

FIG. 3 shows a flow of processing executed between the client terminal 100 and the online storage service providing server 101 via the WEB service providing server 102.

Referring to FIG. 3, the user activates the WEB service regeneration management unit 200 using the user input management unit 203, and then has the WEB service regeneration management unit 200 designate the HTTP address of the WEB service provided by the WEB service providing server 102. As a result, the client terminal 100 makes an access request to the WEB service providing server 102 (S20).

Next, processing for authenticating the user who sent the access request in S20 is executed between the client terminal 100, the WEB service providing server 102, and the online storage service providing server 101 (S21). The type of the authentication method in S21 does not matter in this embodiment, but an authentication method using OpenID (see http://openid.net) will be explained below as an example.

The user registers the user ID with the authentication server 103 and executes processing in S20. Subsequently, the user sends the user ID from the client terminal 100 to the WEB service providing server 102. The WEB service providing server 102 sends the received user ID to the authentication server 103. Then, the authentication server 103 requests a password from the client terminal 100.

The user inputs the password in a password input field displayed on the WEB service regeneration management unit 200, using the user input management unit 203. The WEB service regeneration management unit 200 transfers the input password to the authentication server 103.

The authentication server 103 authenticates the transferred password and transfers the authentication result to the WEB service providing server 102. Subsequently, if it is determined as a result of the transferred authentication result that the authentication was performed properly, the WEB service providing server 102 transfers the WEB service screen to the client terminal 100; and if the authentication failed, the WEB service providing server 102 transfers the result of authentication failure to the client terminal 100.

At the same time as the authentication processing, the WEB service providing server 102 transfers the user ID to the online storage service providing server 101 and the online storage service providing server 101 executes the authentication processing in the same manner as the authentication communications between the WEB service providing server 102 and the authentication server 103.

If it is proved to both the WEB service providing server 102 and the online storage service providing server 101 as a result of the authentication processing that the user ID and the password sent by the user from the client terminal 100 are authentic, the user can receive the service provided by the WEB service providing server 102.

If there is no problem with the authentication result after the authentication processing in S21, the WEB service providing server 102 transfers a message indicating the initial structure of the WEB service to the client terminal 100 (S22), and the online storage service providing server 101 stores user information about sessions performed via the WEB service providing server 102 in order to be able to execute the following processing flow (S23).

Subsequently, the WEB service analysis unit 201 analyzes the WEB service message transferred in S22, transfers the WEB service screen laid out by the WEB service regeneration management unit 200 based on the result of analysis to the display unit 202, and displays the WEB service screen on the display unit 202 (S24).

The user inputs their desired service request from a service menu provided on the WEB service screen displayed in S24, using the user input management unit 203. As a result, the WEB service regeneration management unit 200 sends the service request input by the user to the WEB service providing server 102 via the transfer unit 204 (S25).

Next, the session management unit 401 for the WEB service providing server 102 receives the service request via the transfer unit 400, and the query analysis unit 402 analyzes the service request received by the session management unit 401 (S26). Subsequently, the session management unit 401 makes an inquiry to the online storage service providing server 101 via the transfer unit 400 about necessary data to satisfy the service request (S27).

Incidentally, the processing in S25 is executed in the manner prepared by the WEB service providing server 102 and the processing in S27 is executed in the manner prepared by the online storage service providing server 101. Therefore, processing for converting the query received in S25 to the query sent in S27 is executed in S26.

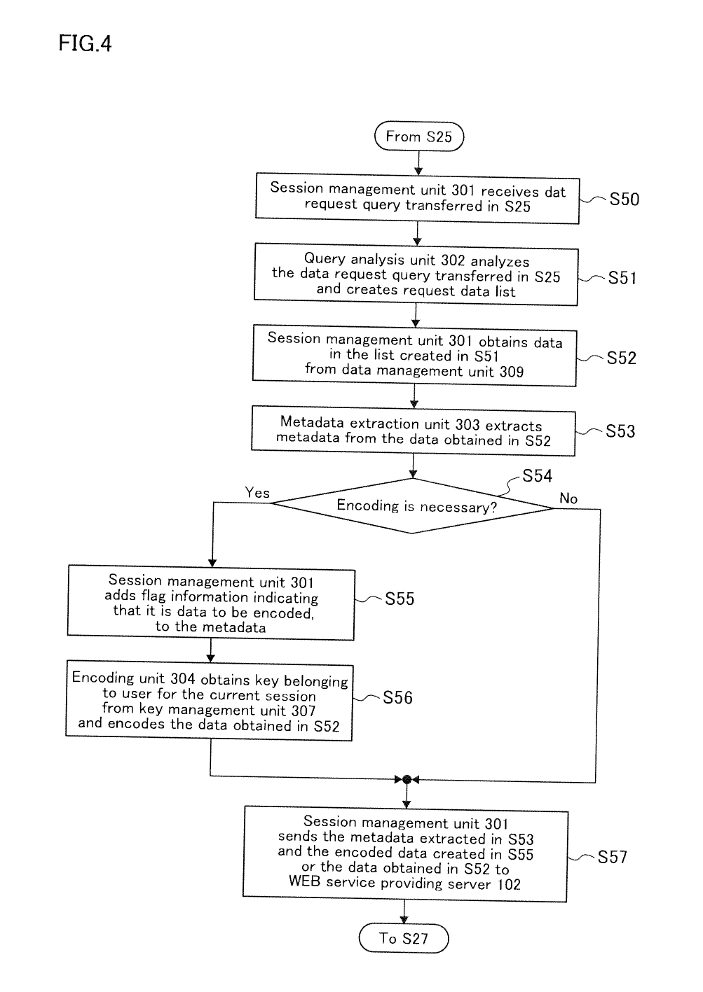

Subsequently, the session management unit 301 for the online storage service providing server 101 receives the query via the transfer unit 300, and the query analysis unit 302 analyzes the query received by the session management unit 301 and transfers data requested based on the result of analysis to the WEB service providing server 102 via the transfer unit 300 (S29). Incidentally, processing between S27 and S29 executed inside the online storage service providing server 101 (S28) will be explained later with reference to FIG. 4.

After receiving the storage service data transferred from the online storage service providing server 101 via the transfer unit 400 in S29, the session management unit 401 for the WEB service providing server 102 delivers the storage service data to the service structure design unit 403. The service structure design unit 403 designs the logical structure of received data for the WEB service and the layout of the WEB service screen based on the received storage service data, generates WEB structure data to construct the WEB service screen, and constructs a WEB service message composed of data including the generated WEB structure data and the storage service data (S30).

Subsequently, the session management unit 401 transfers the WEB service message constructed by the service structure design unit 403 to the client terminal 100 (S31).

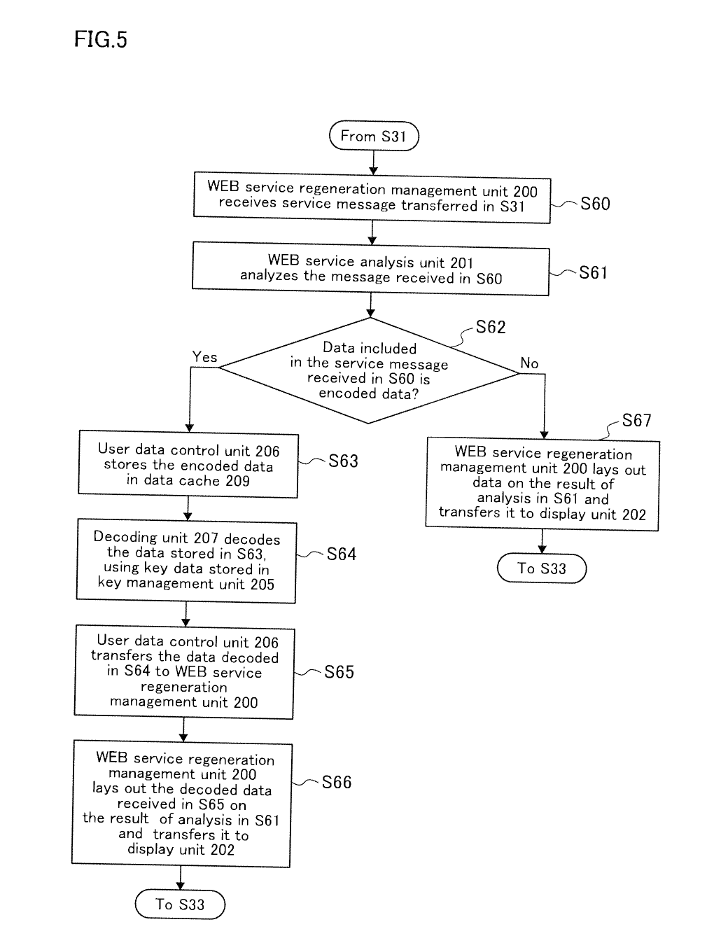

After receiving the WEB service message transferred via the transfer unit 204, the WEB service regeneration management unit 200 for the client terminal 100 regenerates the WEB service screen from the received WEB service message by means of processing in S32, and transfers the regenerated WEB service screen to the display unit 202. The display unit 202 displays the transferred WEB service screen (S33). Incidentally, the detailed operation of S28 will be explained later with reference to FIG. 5.

S34 indicates that the processing from S25 to S33 that takes place every time the user requests the service is repeated. Next, when the user inputs a service termination request to the user input management unit 203, the WEB service regeneration management unit 200 sends the service termination request to the WEB service providing server 102 via the transfer unit 204 (S35).

The session management unit 401 for the WEB service providing server 102 receives the service termination request via the transfer unit 400, and the query analysis unit 402 analyzes the service termination request received by the session management unit 401 (S36), and transfers the service termination request as the result of analysis via the transfer unit 400 to the online storage service providing server 101 (S37).

Subsequently, the session management unit 301 for the online storage service providing server 101 receives a query for the service termination request via the transfer unit 300. The query analysis unit 302 analyzes the query received by the session management unit 301, discards the session information stored as the result of analysis in S23 (S38), and returns a response to the service termination request to the WEB service providing server 102 via the transfer unit 300 (S39).

The session management unit 401 for the WEB service providing server 102 receives the service termination request from the online storage service providing server 101 via the transfer unit 400 and returns a response to the service termination request sent in S35 to the client terminal 100 via the transfer unit 400 (S40).

FIG. 4 shows the detailed processing flow of S28 in FIG. 3.

Referring to FIG. 4, the session management unit 301 for the online storage service providing server 101 receives the data request query transferred in S25 in FIG. 3 via the transfer unit 300 (S50) and delivers the received data request query to the query analysis unit 302. The query analysis unit 302 analyzes the received data request query and creates a list of data requested by the WEB service providing server 102 based on the result of analysis (S51).

The session management unit 301 receives the data list created in S51 from the query analysis unit 302 and requests data belonging to the created list from the data management unit 309. In response to the request from the session management unit 301, the data management unit 309 extracts content data groups requested by the session management unit 301 from the content data stored in the content database 310 and delivers the extracted content data groups to the session management unit 301 (S52).

The session management unit 301 delivers the received content data groups to the metadata extraction unit 303. The metadata extraction unit 303 extracts the respective different types of metadata defined above from the received content data groups (S53). Subsequently, the session management unit 301 checks whether information about the WEB service providing server 102 which issued the data request query received in S50 is stored in the site information database 312 via the site management unit 311 or not (S54).

If the information about the WEB service providing server 102 which issued the data request query received in S50 is not stored in the site information database 312, the session management unit 301 adds flag information indicating that each of the received content data groups is data to be encrypted, to the metadata extracted in S53 (S55).

The session management unit 301 delivers the content data groups received in S52 to the encrypting unit 304, and the encrypting unit 304 encrypts each of the received content data groups (S56). The session management unit 301 transfers the storage service data composed of data including the metadata extracted in S53 and the content data encrypted in S56, to the WEB service providing server 102 via the transfer unit 300 (S57).

FIG. 5 shows the detailed processing flow of S32 in FIG. 3.

Referring to FIG. 5, the WEB service regeneration management unit 200 for the client terminal 100 receives the WEB service message transferred in S31 in FIG. 3 via the transfer unit 204 (S60). The WEB service analysis unit 201 analyzes the WEB service message received by the WEB service regeneration management unit 200 (S61).

If it is necessary to process data added to the WEB service message provided by the online storage service providing server 101 in the analysis of the WEB service message by the WEB service analysis unit 201 in S61, the WEB service analysis unit 201 checks whether the data added to the WEB service message includes any encrypted data or not, in consideration of, for example, the possibility that the online storage service providing server 101 and the WEB service providing server 102 are managed by different administrators (S62).

If the WEB service message includes the encrypted data, the WEB service analysis unit 201 delivers the encrypted data to the user data control unit 206, and the user data control unit 206 stores the encrypted data delivered from the WEB service analysis unit 201 in the data cache 209 (S63).

When the service structure design unit 403 for the WEB service providing server 102 constructs the WEB service message in S30, if it is confirmed by referring to the metadata transferred together with the encrypted data in S57 that the data transferred in S57 is encrypted, a message may be added to the WEB service message to be designed in order to notify that the data has been encrypted, or the WEB service message may be constructed by cooperation among the user data control unit 206, the decrypting unit 207, the data management unit 208, and the data cache 209, so that the WEB service analysis unit 201 can judge whether the WEB service message received from the WEB service providing server 102 includes the encrypted data or not.

Subsequently, the user data control unit 206 requests that the decrypting unit 207 decrypts the encrypted data stored in the data cache 209 in S63, using the key data stored in the key management unit 205 (S64); and the user data control unit 206 transfers the content data decrypted in S64 to the WEB service regeneration management unit 200 (S65).

The WEB service regeneration management unit 200 lays out the content data encrypted in S65 on the WEB service message analyzed by the WEB service analysis unit 201 in S61 and transfers the laid out data to the display unit 202 (S66).

If it is unnecessary to encrypt the content data provided by the online storage service providing server 101 to the WEB service providing server 102, in other words, if the WEB service providing server 102 is supplied by the vendor that supplies the online storage service providing server 101, or if it is proved that the WEB service providing server 102 will not make unauthorized secondary use of the data, the online storage service providing server 101 does not have to perform encrypting in S54.

In this case, the WEB service analysis unit 201 determines in S62 that the encrypted data is not included, and the WEB service regeneration management unit 200 lays out photographic data included in the WEB service message received in S60 without any modification on the WEB service message analyzed by the WEB service analysis unit 201 in S61 and transfers the laid out photographic data to the display unit 202 (S67).

Even if the content data provided by the online storage service providing server 101 is encrypted, the above-described configuration enables the WEB service providing server 102 to provide the user with the WEB service that complies with the service request, for example, the WEB service screen, by using the metadata, which is not encrypted, in the online service data provided by the online storage service providing server 101.

Even if the WEB service providing server 102 with malicious intention gives the content data provided by the online storage service providing server 101 to a third party in an attempt to make secondary use of the content data, the user's privacy will not be infringed upon because the content data provided by the online storage service providing server 101 to the WEB service providing server 102 is encrypted.

Since the metadata, which is not encrypted, in the online service data provided by the online storage service providing server 101 is used according to the first embodiment, the WEB service providing server 102 can provide the client terminal 100 with the WEB service and it is possible to prevent the WEB service providing server 102 from making unauthorized secondary use of the content data provided by the online storage service providing server 101, thereby preventing infringement upon the user's privacy.

### Second Embodiment

The second embodiment of the present invention will be explained below in detail with reference to the relevant drawings.

The second embodiment is designed so that an online storage service providing server encrypts a coding portion data in content data, provides a WEB service providing server with storage service data composed of the encrypted coding portion data and side information storage portion data which is additional information for the content data; and the WEB service providing server constructs a WEB service message according to the side information storage portion data in the storage service data provided by the online storage service providing server and provides a client terminal with data relating to the constructed WEB service message.

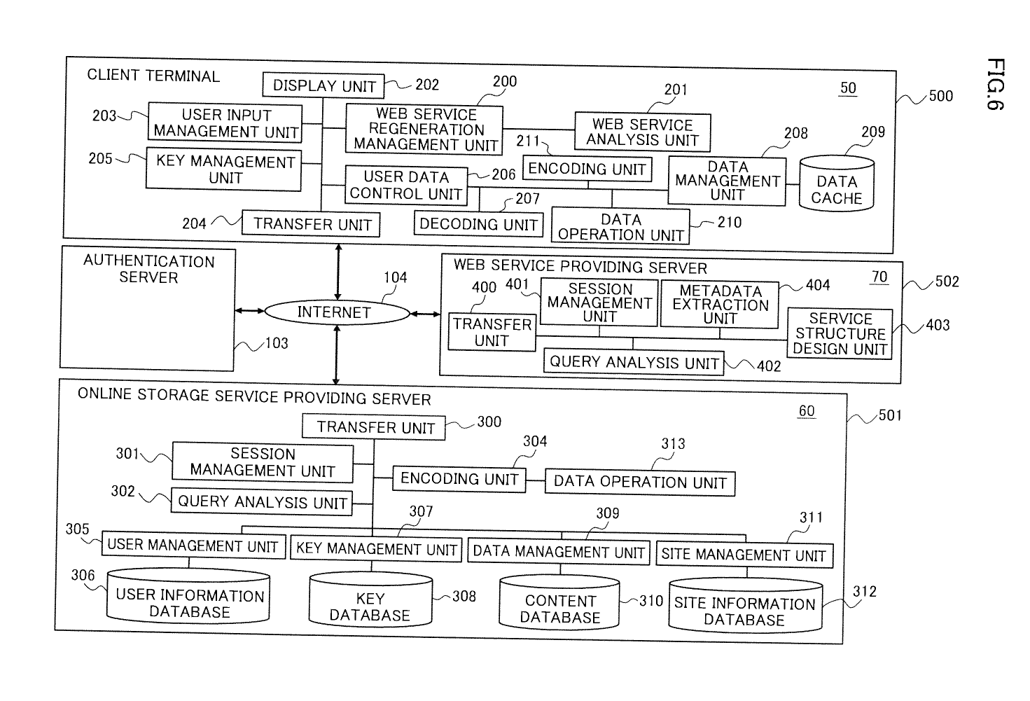

FIG. 6 is a block diagram of an online storage service system according to the second embodiment of the present invention.

Referring to FIG. 6, the online storage service system is constituted from a client terminal 500, an online storage service providing server 501, a WEB service providing server 502, and an authentication server 103.

The client terminal 500 includes a terminal control device 50. The terminal control device 50 is constituted from a WEB service regeneration management unit 200, a WEB service analysis unit 201, a display unit 202, a user input management unit 203, a transfer unit 204, a key management unit 205, a user data control unit 206, a decrypting unit 207, a data management unit 208, a data cache 209, a data operation unit 210, and an encrypting unit 211. The terminal control device 50 has the same configuration as that of the terminal control device 20, except that it includes the data operation unit 210 and the encrypting unit 211.

The data operation unit 210 separates data (for example, content data that is the user's data) input to the data operation unit 210 into side information storage portion data and coding portion data, and recombines two pieces of data input to the data operation unit 210, for example, the side information storage portion data and the coding portion data.

Incidentally, regarding the side information storage portion data and the coding portion data in the case of, for example, JPEG which is the digital format for photographs, or MPEG which is the digital format for music and moving images, the digital format is composed of the side information storage portion in which metadata in the content data can be stored, and the coding portion in which coded data itself in the content data can be stored.

The encrypting unit 211 encrypts data input to the encrypting unit 211, for example, data stored in the coding portion, using key data stored in the key management unit 205.

The online storage service providing server 501 includes a storage control device 60. The storage control device 60 is constituted from a transfer unit 300, a session management unit 301, a query analysis unit 302, an encrypting unit 304, a user management unit 305, a user information database 306, a key management unit 307, a key database 308, a data management unit 309, a content database 310, a site management unit 311, a site information database 312, and a data operation unit 313. The storage control device 60 has the same configuration as that of the storage control device 30, except that it includes the data operation unit 313. Incidentally, the data operation unit 313 is similar to the data operation unit 210.

The WEB service providing server 502 includes a WEB service control device 70. The WEB service control device 70 is constituted from a transfer unit 400, a session management unit 401, a query analysis unit 402, a service structure design unit 403, and a metadata extraction unit 404. The WEB service control device 70 has the same configuration as that of the WEB service control device 40, except that it includes the metadata extraction unit 404.

As in the case of the metadata extraction unit 303, the metadata extraction unit 404 extracts the metadata defined above from data into the metadata extraction unit 404.

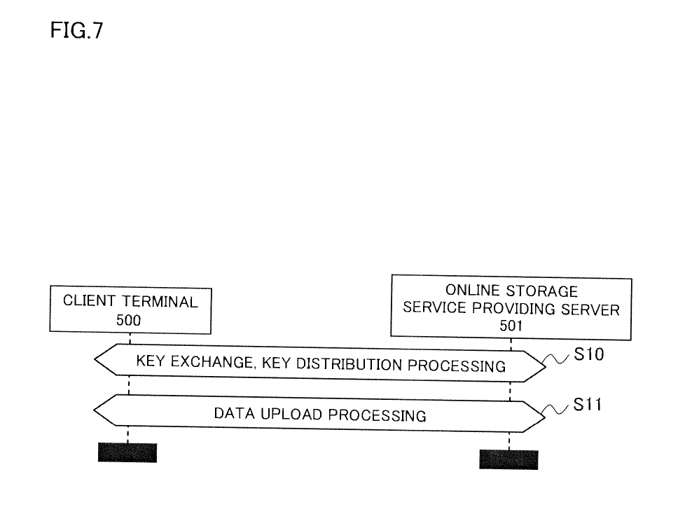

The operation of the online storage service system according to the second embodiment will be explained below with reference to FIGS. 7 to 10.

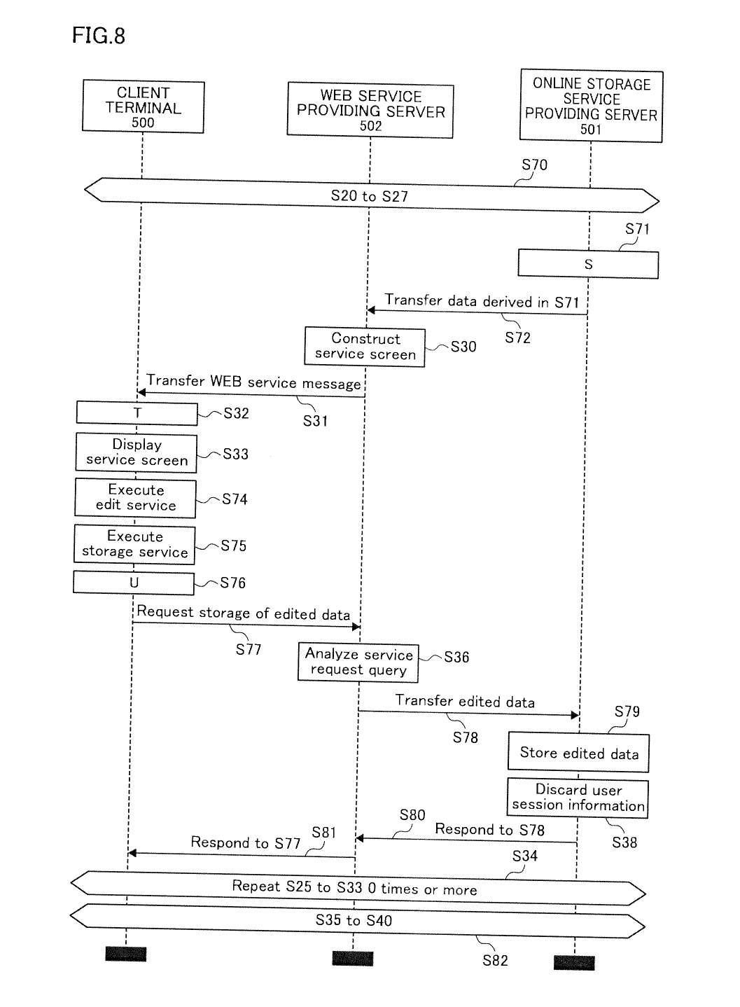

FIG. 7 shows a flow of processing executed between the client terminal 500 and the online storage service providing server 501. The processing flow shown in FIG. 7 has to be executed before the processing flow shown in FIGS. 8 to 10. Incidentally, FIG. 7 shows the processing similar to that shown in FIG. 2 and, therefore, an explanation of that processing has been omitted.

FIG. 8 shows a flow of processing executed between the client terminal 500 and the online storage service providing server 501 via the WEB service providing server 502. Incidentally, the content of processing indicated in FIG. 8 with the same numbers as those in FIG. 3 is the same as that in FIG. 3 and, therefore, an explanation of that processing has been omitted.

Referring to FIG. 8, S70 indicates the processing in S20 to S27 in FIG. 3. After S70, the session management unit 301 for the online storage service providing server 501 receives the query processed in S27 via the transfer unit 300 and delivers the received query to the query analysis unit 302. The query analysis unit 302 analyzes the received query, generates storage service data requested based on the result of analysis, and transfers the generated storage service data via the transfer unit 300 to the WEB service providing server 502 (S72).

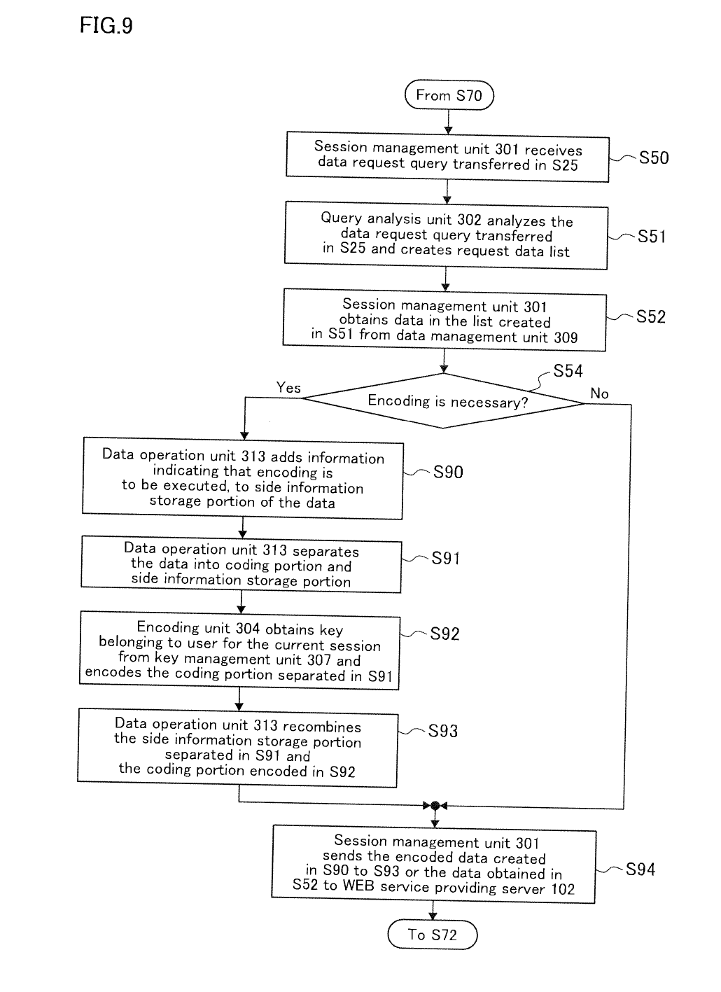

Incidentally, processing executed inside the online storage service providing server 501 between S27 and S72 (S71) will be explained with reference to FIG. 9. After S72, the WEB service providing server 502 generates WEB structure data necessary to construct a service screen and transfers a WEB service message, which is composed of data including the generated WEB structure data and the storage service data, to the client terminal 500 (S30, S31).

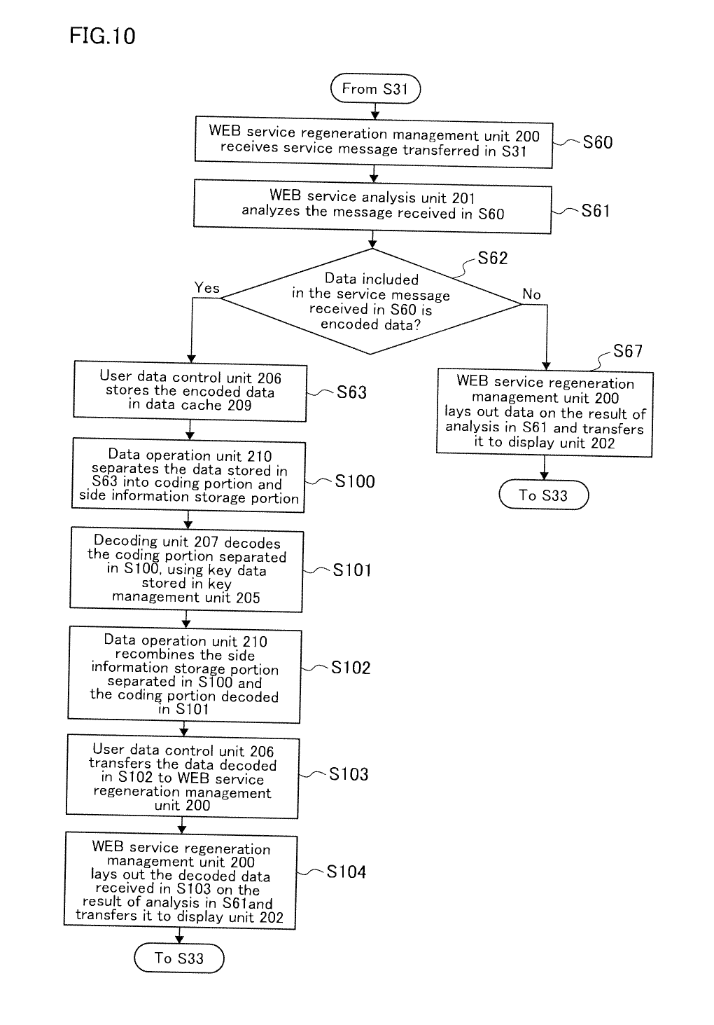

After receiving the WEB service message via the transfer unit 204, the WEB service regeneration management unit 200 for the client terminal 500 regenerates the WEB service screen by processing in S73 from the WEB service message transferred in S31 and transfers the regenerated WEB service screen to the display unit 202. The display unit 202 displays the transferred WEB service screen (S33). Incidentally, the detailed operation of S73 will be explained later with reference to FIG. 10.

As a result of the processing executed above, the WEB service providing server 502 can construct the WEB service screen based on the online service data provided by the online storage service providing server 501 and provide the client terminal 500 with the WEB service message composed of data including the WEB structure data relating to the constructed WEB service screen and the online service data.

Furthermore, the WEB service providing server 102 can edit data provided by the online storage service providing server 101 and provide the client terminal 500 with the WEB service based on the edited data by executing processing described below.

Specifically speaking, as a result of the processing from S20 to S33 in FIG. 8, the WEB service screen constructed by the service structure design unit 403 for the WEB service providing server 502 based on the online service data provided by the online storage service providing server 501 is displayed on the service layout of the display unit 202 for the client terminal 500.

Also, the service structure design unit 403 for the WEB service providing server 502 realizes, on the WEB service screen, a tool capable of editing the online service data provided by the online storage service providing server 101.

If the online service data provided by the online storage service providing server 501 is photographic data, the service structure design unit 403 provides an editing service for, for example, painting the background of the photographic data and adding comments to the photographic data and a service for changing the color of part of the photographic data.

In this case, the user first has the WEB service regeneration management unit 200 edit the data using the user input management unit 203 (S75). Next, the user inputs an edited data storage request to the user input management unit 203. When the edited data storage request is input to the user input management unit 203, processing of S76 is executed as described later. Subsequently, the WEB service regeneration management unit 200 sends the edited data storage request query and the data created in S76 to the WEB service providing server 502 via the transfer unit 204 (S77).

The session management unit 401 for the WEB service providing server 502 receives the edited data storage request query and the data created in S76 via the transfer unit 400. The query analysis unit 402 analyzes the edited data storage request query received by the session management unit 401 (S36). The session management unit 401 sends the edited data storage request query and the data created in S76 to the online storage service providing server 501 via the transfer unit 400 based on the result of analysis by the query analysis unit 402 (S78).

The session management unit 301 for the online storage service providing server 501 receives the edited data storage request query and the data created in S76 via the transfer unit 300. The query analysis unit 302 analyzes the edited data storage request query received by the session management unit 301. Based on the result of analysis by the query analysis unit 302, the session management unit 301 stores the received data (S79), discards the session information stored in S23 (S38), and returns a response to S78 to the WEB service providing server 502 via the transfer unit 300 (S80).

After receiving the response from the online storage service providing server 501 via the transfer unit 400, the session management unit 401 for the WEB service providing server 502 returns a response to the edited data storage request in S77 to the client terminal 500 via the transfer unit 400 (S81). Subsequently, processing of S34 is executed; and then processing of S82 (which is processing from S35 to S40) is finally executed.

FIG. 9 shows the detailed processing flow of S71 in FIG. 8.

Referring to FIG. 9, processing from S50 to S54 is executed by the online storage service providing server 501 as in the case of FIG. 4. If it is necessary in S54 to encrypt each of the data groups received in S50, the data operation unit 313 adds flag information indicating that the coding portion data in the content data should be encrypted, to the side information storage portion in the content data (S90).

Incidentally, if the coding portion data is a JPEG file, the flag information may be added to an application flag area APPn in a head portion of the JPEG format.

Subsequently, the data operation unit 313 separates the content data into the coding portion data and the side information storage portion data (S91). The encrypting unit 304 obtains key data belonging to the user for the current session from the key database 308 via the key management unit 307, using the user information stored in S23 about the user for the current session, and encrypts only the coding portion data separated by the data operation unit 313 based on the obtained key data (S92).

Incidentally, the encrypting unit 304 encrypts the coding portion data by pixels if the relevant data is photographs or moving images; and the encrypting unit 304 encrypts the coding portion data by frames, blocks, or subbands if the relevant data is music. For example, regarding JPEG image data, Huffman decoding of the coding portion data is performed once, and then zero-run expansion and inverse DPCM (Differential Pulse Code Modulation) are carried out to encrypt the coding portion data at least in the quantization level.

Subsequently, the data operation unit 313 recombines the side information storage portion data separated in S91 and the coding portion data encrypted in S92 (S93). The session management unit 301 transfers online service data composed of data including the side information storage portion data and the encrypted coding portion data which were recombined by the data operation unit 313, to the WEB service providing server 502 via the transfer unit 300 (S94).

FIG. 10 shows the detailed processing flow of S73 in FIG. 8.

Referring to FIG. 10, processing from S60 to S63 is executed by the client terminal 500 as in the case of FIG. 5. In this case, the data operation unit 210 separates the data stored in the data cache 209 in S63, which is the content data added to the WEB service message, into the coding portion data and the side information storage portion data (S100). The decrypting unit 207 decrypts only the coding portion data separated by the data operation unit 210, using the key data stored in the key management unit 205 (S101).

Incidentally, the decrypting unit 207 decrypts the coding portion data by pixels if the relevant data is photographs or moving images; and the decrypting unit 207 decrypts the coding portion data by frames, blocks, or subbands if the relevant data is music. For example, regarding JPEG image data, Huffman decoding of the coding portion data is performed once, and then zero-run expansion and inverse DPCM (Differential Pulse Code Modulation) are carried out to decrypt the coding portion data at least in the quantization level.

Subsequently, the data operation unit 210 recombines the side information storage portion data separated in S100 and the coding portion data decrypted in S101 (S102). The user data control unit 206 transfers the side information storage portion data and the decrypted coding portion data, which were recombined by the data operation unit 210, to the WEB service regeneration management unit 200 (S103). The WEB service regeneration management unit 200 lays out the side information storage portion data and the decrypted coding portion data, which were recombined by the data operation unit 210, on the WEB service message analyzed by the WEB service analysis unit 201 in S61, and then transfers the laid out data to the display unit 202 (S104).

Incidentally, when the service structure design unit 403 for the WEB service providing server 502 constructs the WEB service message in S30, the metadata in the online service data transferred from the online storage service providing server 501 can be accessed without any difficulty. Therefore, there is no problem with provision of the WEB service.

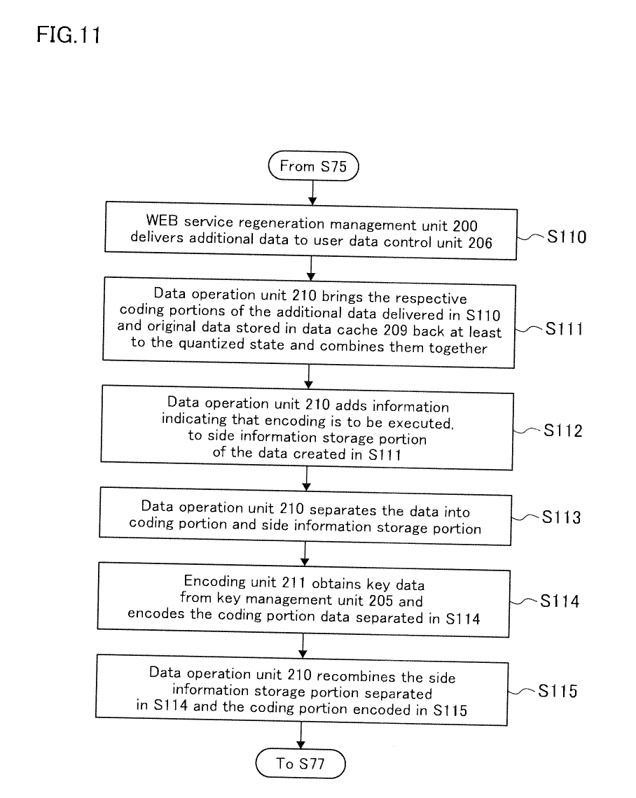

Referring to FIG. 11, the WEB service regeneration management unit 200 delivers additional data, which has been input by the user to the user input management unit 203, to the user data control unit 206 (S110). The data operation unit 210 converts the additional data delivered to the user data control unit 206 and the decrypted data stored in the data cache 209, i.e., the coding portion data in each pieces of the content data downloaded from the online storage service providing server 501, at least to the quantized state.

Under this circumstance, the data operation unit 210 adds each quantized block of the coding portion in the additional data to a quantized block corresponding to the coding portion (which is the decrypted data stored in the data cache 209) in the content data downloaded from the online storage service providing server 101 (S111).

Next, the data operation unit 313 adds flag information indicating that encrypting is to be performed, to the side information storage portion in the content data created in S111 (S112). The data operation unit 313 separates the content data into the coding portion data and the side information storage portion data (S113). The encrypting unit 211 obtains the key data from the key management unit 205 and encrypts only the coding portion data separated by the data operation unit 313 based on the obtained key data (S114). Incidentally, the encrypting unit 211 may encrypt the coding portion by quantized blocks or by the coding portion unit.

Subsequently, the data operation unit 313 recombines the side information storage portion data and the coding portion data encrypted by the encrypting unit 211, which were separated (S115).

Because of the configuration described above, the WEB service providing server 502 can construct a flexible WEB service that is not limited by the type of metadata provided by the online storage service providing server 501, and that can not only just display and regenerate data, but also edit the regenerated data.

According to this embodiment, the WEB service providing server 502 can provide the client terminal 500 with the WEB service by using the side information storage portion data (metadata), which is not encrypted, in the online service data provided by the online storage service providing server 501; and it is also possible to prevent the WEB service providing server 502 from making unauthorized secondary use of the content data provided by the online storage service providing server 501, thereby preventing infringement upon the user's privacy.

Furthermore, according to this embodiment, the online service data provided by the online storage service providing server 501 to the WEB service providing server 502 is composed of the content data including the side information storage portion data (metadata), which is not encrypted, and the encrypted coding portion data. As a result, the amount of transferred data can be reduced as compared to the first embodiment where the online service data includes the encrypted content data and the metadata which is not encrypted.

### INDUSTRIAL APPLICABILITY

When data is transferred between a client and a server and between servers, the present invention is effective in a system that prevents unauthorized secondary use of data retained by a transmitter without interfering with a receiver's use of the data. Specifically speaking, the invention can be used for a system for delivering data between an SNS service providing server and an application service providing server.

### DESCRIPTION OF REFERENCE NUMERALS

Terminal control devices 20, 50; storage control devices 30, 60; WEB service control devices 40, 70; client terminals 100, 500; online storage service providing servers 101, 501; WEB service providing servers 102, 502; authentication server 103; WEB service regeneration management unit 200; WEB service analysis unit 201; display unit 202; user input management unit 203; transfer unit 204; key management unit 205; user data control unit 206; decrypting unit 207; data management unit 208; data cache 209; data operation unit 210; encrypting unit 211; transfer unit 300; session management unit 301; query analysis unit 302; metadata extraction unit 303; encrypting unit 304; user management unit 305; user information database 306; key management unit 307; key database 308; data management unit 309; content database 310; site management unit 311; site information database 312; data operation unit 312; transfer unit 400; session management unit 401; query analysis unit 402; service structure design unit 403; and metadata extraction unit 404.

1. Online storage service system comprising:
an online storage service providing server for storing content data relating to a client terminal coupled to a network, in storage devices; and
a WEB service providing server coupled via the network to the client terminal and the online storage service providing server, for providing the client terminal with a WEB service via the network;
wherein the WEB service providing server includes a WEB service control device that requests, in response to a service request from the client terminal, provision of data designated by the service request from the online storage service providing server, generates WEB structure data that complies with the service request, based on storage service data provided by the online storage service providing server, and provides the client terminal with a WEB service message composed of data including the generated WEB structure data and the storage service data; and
wherein the online storage service providing server includes a storage control device that, in response to a request from the WEB service providing server, extracts the content data from the storage devices, encrypts at least part of the extracted content data, and provides the WEB service providing server with the storage service data composed of data including the encrypted content data.

2. The online storage service system according to claim 1, wherein the WEB service control device includes:
a first transfer unit coupled to the network for sending/receiving data to/from the client terminal or the online storage service providing server;
a first query analysis unit for analyzing the service request when the first transfer unit receives the service request from the client terminal;
a service structure design unit for designing a service structure relating to the WEB service based on metadata in the storage service data when the first transfer unit receives the storage service data from the online storage service providing server; and
a first session management unit for requesting that the online storage service providing server provides, via the first transfer unit, data necessary to satisfy the service request data based on the result of analysis by the first query analysis unit, and for transferring a WEB service message including data about the service structure designed by the service structure design unit and the storage service data received by the first transfer unit, via the first transfer unit to the client terminal; and
wherein the storage control device includes:
a second transfer unit coupled to the network for sending/receiving data to/from the client terminal or the WEB service providing server;
a second query analysis unit for analyzing a request from the WEB service providing server and creating a request data list to satisfy the request when the second transfer unit receives the request from the WEB service providing server;
a content database storing the content data;
a data management unit for extracting the content data from the content database in accordance with the request data list created by the second query analysis unit;
an encrypting unit for encrypting the content data extracted by the data management unit;
a metadata extraction unit for extracting metadata from the content data extracted by the data management unit; and
a second session management unit for providing the WEB service providing server via the second transfer unit the storage service data composed of data including the content data encrypted by the encrypting unit and the metadata extracted by the metadata extraction unit.

3. The online storage service system according to claim 1, wherein the storage control device encrypts the content data extracted from the storage devices, extracts side information storage portion data, which is additional information of the extracted content data, from the extracted content data, and provides the WEB service providing server with the storage service data composed of data including the encrypted content data and the extracted side information storage portion data; and
wherein the WEB service control device extracts the side information storage portion data from the storage service data provided by the storage control device for the online storage service providing server and generates WEB structure data that complies with the service request from the client terminal based on the extracted side information storage portion data.

4. The online storage service system according to claim 1, wherein the storage control device separates the content data extracted from the storage devices into coding portion data and side information storage portion that is additional information for the coding portion, encrypts the separated coding portion data, and provides the WEB service providing server with the storage service data composed of data including the encrypted coding portion data and the separated side information storage portion data; and
wherein the WEB service control device extracts the separated side information storage portion data from the storage service data provided by the storage control device for the online storage service providing server and generates WEB structure data that complies with the service request from the client terminal, based on the extracted side information storage portion data.

5. The online storage service system according to claim 1, wherein the client terminal includes a terminal control device for sending the service request to the WEB service providing server, decrypting the encrypted data in the WEB service message provided by the WEB service providing server, laying out a page structure based on the decrypted data and the WEB structure data in the WEB service message provided by the WEB service providing server, and displaying the laid out page structure on screen.

6. The online storage service system according to claim 1, wherein the client terminal includes a terminal control device for extracting the encrypted content data from the WEB service message provided by the WEB service providing server, decrypting the extracted content data, laying out a page structure based on the decrypted content data and the WEB structure data in the WEB service message provided by the WEB service providing server, and displaying the laid out page structure on screen.

7. The online storage service system according to claim 1, wherein the client terminal includes a terminal control device for extracting the encrypted coding portion data from the WEB service message provided by the WEB service providing server, decrypting the extracted coding portion data, laying out a page structure based on the decrypted coding portion data and the WEB structure data in the WEB service message provided by the WEB service providing server, and displaying the laid out page structure on screen.

8. A data control method for an online storage service system including:
an online storage service providing server for storing content data relating to a client terminal coupled to a network, in storage devices; and
a WEB service providing server coupled via the network to the client terminal and the online storage service providing server, for providing the client terminal with a WEB service via the network;
wherein the WEB service providing server executes a request step of requesting, in response to a service request from the client terminal, that the online storage service providing server provides data designated by the service request;
wherein the online storage service providing server executes:
a data extraction step of extracting the content data from the storage devices in response to a request from the WEB service providing server;
an encrypting step of encrypting at least part of the content data extracted in the above data extraction step; and
a service data provision step of providing the WEB service providing server with storage service data including the content data encrypted in the encrypting step; and
wherein the WEB service providing server further executes:
a data generation step of generating WEB structure data that complies with the service request from the client terminal, based on the storage service data provided by the online storage service providing server; and
a message provision step of providing the client terminal with a WEB service message including the WEB structure data generated in the data generation step and the storage service data.

9. The data control method for the online storage service system according to claim 8, wherein in the data extraction step, the online storage service providing server extracts the content data from the storage devices and also extracts side information storage portion data, which is additional information for the extracted content data, from the extracted content data;
in the encrypting step, the online storage service providing server encrypts the entire content data extracted in the data extraction step; and
in the service data provision step, the online storage service providing server provides the WEB service providing server with the storage service data composed of data including the content data encrypted in the encrypting step and the side information storage portion data extracted in the data extraction step; and
wherein prior to the data generation step, the WEB service providing server executes a side information extraction step of extracting the side information storage portion data from the storage service data provided by the online storage service providing server; and
in the data generation step, the WEB service providing server generates WEB structure data that complies with the service request from the client terminal, based on the side information storage portion data extracted in the side information extraction step.

10. The data control method for the online storage service system according to claim 8, wherein after the data extraction step, the online storage service providing server executes a separation step of separating the content data extracted in the data extraction step into coding portion data and side information storage portion data that is additional information for the coding portion;
in the encrypting step, the online storage service providing server encrypts the coding portion data separated in the separation step; and
in the service data provision step, the online storage service providing server provides the WEB service providing server with the storage service data composed of data including the side information storage portion data separated in the separation step and the coding portion data encrypted in the encrypting step; and
wherein prior to the data generation step, the WEB service providing server executes a side information extraction step of extracting the side information storage portion data from the storage service data provided by the online storage service providing server; and
in the data generation step, the WEB service providing server generates WEB structure data that complies with the service request from the client terminal, based on the side information storage portion data extracted in the side information extraction step.

11. The data control method for the online storage service system according to claim 8, wherein the client terminal executes:
a transmission step of transmitting the service request to the WEB service providing server;
a decrypting step of decrypting the encrypted content data in the WEB service message provided by the WEB service providing server; and
a display step of laying out a page structure based on the content data decrypted in the decrypting step and the WEB structure data in the WEB service message provided by the WEB service providing server and displaying the laid out page structure on screen.
